(19) United States
(12) Patent Application Publication
(10) Pub. No.: US 2004/0146733 A1
(43) Pub. Date: Jul. 29, 2004

(54) Method for the protective treatment of wood and derived timber products

(76) Inventors: Joachim Fritschi, Lorrach (DE); Florian Licthenberg, Grenzach-Wyhlen (DE); Hans-Norbert Marx, B?uuml;hl (DE)

Correspondence Address: FISHER, CHRISTEN & SABOL, 1725 K STREET, N.W., SUITE 1108, WASHINGTON, DC, 20006, US

(21) Appl. No.: 10/473,746

(22) PCT Filed: Mar. 25, 2002
(86) PCT No.: PCT/EP02/03308

(30) Foreign Application Priority Data
Apr. 3, 2001 (EP) 01108389.6

(51) Int. Cl. B05D 3/02

(52) U.S. Cl. 428/537.1; 427/393

(57) ABSTRACT

The invention relates to a method for the protective treatment of wood, derived timber products and wood-type substrates by means of thermal treatment at 60-250° C. and additional treatment using an amine and/or amine derivative of general formula (Ia), (Ib) or (Ic) wherein R¹ and R⁴ independently represent C₆₋₂₄ alkyl; R² and R³ independently represent C₁₋₂₄ alkyl or (CH₂)—NH₂; R⁵, R⁶, R⁸ and R⁹ independently represent C₁₋₂₄ Alkyl; R⁷ represents C₆₋₂₄ alkyl or benzyl; R¹⁰ independently represents C₁₋₂₄ alkyl or —[(CH₂)₂—O]ₙR¹¹ where n=1-20; R¹¹ represents hydrogen or optionally substituted phenyl; and X⁻ represents a monovalent inorganic or organic anion or an equivalent of a polyvalent inorganic or organic anion. The additional treatment can also be carried out using a corresponding salt the wood treated according to said method has good resistance even to harmful organisms which cannot be reliably controlled by means of only a heat treatment. The inventive method is carried out without compounds containing heavy metals and the wood treated in this way has no impact on the environmental either during the use or during the disposal thereof.

The invention relates to a combined physicochemical method for the treatment of wood, derived timber products and wood-like substrates for protection against wood-destroying organisms.

It has been known for some time that the treatment of wood or like substrates with dry or moist heat in a temperature range of from 80 to 300° C. over hours to days not only kills any pests which may be present, but also leads to a change in the wood as such and, as a consequence, to an improved resistance to wood-destroying organisms. Experience has shown that this resistance increases with increasing temperatures attained and with increasing residence times at this temperature. However, temperatures above 250° C. and long residence times (for example >10 h) bring about a marked deterioration of the mechanical properties of the timber treated thus which is essentially caused by partial decomposition or depolymerization of the cellulose present. This damage which is suffered by the wood prevents the universal application of the method to structural timber and construction timber. A further disadvantage of this method is the fact that the resistance which can be attained by means of the heat treatment does not act equally well against all wood-destroying organisms. The fungi from the group of the polyporous building-rot fungi (family Coriolaceae and the like), in particular, mostly degrade the heat-treated wood to the same extent as untreated comparison samples. This fact reduces the value of the heat-treated wood considerably since wood-destroying Basidiomycetes from the abovementioned group constitute the most important wood decay fungi. They include, in particular, the mine rot Antrodia vaillantii, which causes immense economic damage in timber components. The concept of being able to permanently employ in the various danger categories common wood species (for example Picea alba), which have little natural resistance without resorting to chemical wood preservatives, which is desirable for ecological reasons, is therefore feasible only to a negligible extent. This means that the possibility which this technology aims at, namely the simplified disposal of thermally treated timber—in comparison with conventionally chemically protected timber—thus also becomes irrelevant.

It was thus an object of the present invention to provide a method for the protective treatment of wood and derived timber products which is based on a heat treatment, but without the abovementioned disadvantages.

This object is achieved in accordance with the invention by the method as claimed in claim 1 and the resulting treated timber, derived timber products and wood-like substrates as claimed claim 5.

Surprisingly, it has been found that certain alkylamine derivatives, viz. those of the formulae

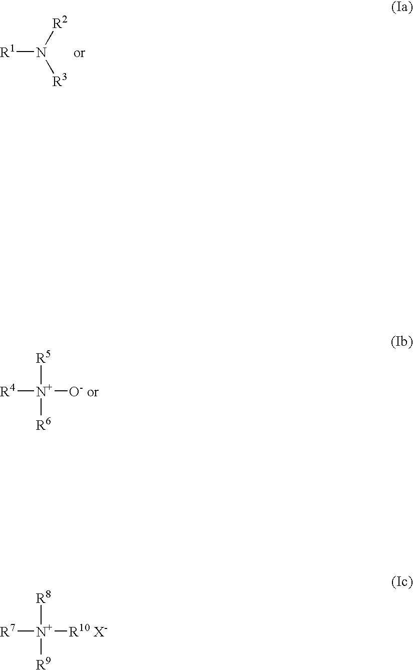

in which independently of one another

R¹ and R⁴ are C₆₋₂₄-alkyl,

R² and R³ are C₁₋₂₄-alkyl or CH₂)₃—NH₂,

R⁵, R⁶, R⁸ and R⁹ are C₁₋₂₄-alkyl,

R⁷ is C₆₋₂₄-alkyl or benzyl,

R¹⁰ is C₁₋₂₄-alkyl or —[(CH₂)₂—O]ₙR¹¹ where n 1-20,

R¹¹ is hydrogen or optionally substituted phenyl

and X⁻ is a monovalent inorganic or organic anion or an equivalent of a polyvalent inorganic or organic anion

are capable of effectively preventing attack by the abovementioned harmful fungi when introduced even in small amounts into the wood or the derived timber product which has undergone heat treatment at 60-250° C. or prior to the heat treatment.

Derived timber products here and hereinbelow are understood as meaning in particular laminated boards, plywood, composite boards, particle boards and wood fiber boards. Wood-like substrates are understood as meanings products of vegetable origin with a composition similar to that of wood, for example bamboo, reed and materials obtainable from these.

C_{x-y}-alkyl here and hereinbelow is understood as meaning all linear or branched alkyl groups having x to y carbon atoms; thus C₁₋₂₄-alkyl is understood as meaning for example methyl, ethyl, propyl, isopropyl, butyl, isobutyl, sec-butyl, tert-butyl, pentyl, isopentyl, tert-pentyl, neopentyl, hexyl, isohexyl, heptyl, octyl, decyl, dodecyl (lauryl), tetradecyl (myristyl), hexadecyl (cetyl), octadecyl (stearyl), eicosyl (arachidyl), docosyl (behenyl) or tetracosyl (lignoceryl).

Substituted phenyls is understood as meaning in particular those phenyl groups which have attached to them one or more identical or different substituents from the group consisting of halogen, C₁₋₆-alkyl groups and C₁₋₆-alkoxy groups.

Monovalent inorganic anions are understood as meaning in particular halides such as fluoride, chloride, bromide or iodine, nitrate, hydrogen sulfate and dihydrogen phosphate.

Monovalent organic anions are understood as meaning in particular the anions of lower carboxylic acids such as formate, acetate, propionate or lactate, or aliphatic or aromatic sulfonic acids such as methanesulfonate, benzenesulfonate or toluenesulfonate.

Polyvalent inorganic anions are understood as meaning for example sulfate, monohydrogen phosphate or phosphate.

Polyvalent organic anions are understood as meaning for example oxalate, malonate, tartrate, malate, maleate, fumarate or phthalate.

Preferred amines (Ia) are in particular those in which iron is R¹ is C₈₋₁₈-alkyl and R² and R³ are methyl or —(CH₂)₃—NH₂.

Preferred amine derivatives Ib (amine oxides) are in particular those in which R⁴ is C₈₋₁₈-alkyl and R⁵ and R⁶ are methyl groups.

Preferred amine derivatives Ic (quaternary ammonium salts) are in particular those in which R⁷ is a C₈₋₁₈-alkyl group or a benzyl group, R⁸ is a C₈₋₁₈-alkyl group and R⁹ and R¹⁰ are methyl groups or R⁷ and R⁸ are C₈₋₁₈-alkyl groups, R⁹ is a methyl group and R¹⁰ is a group of the formula —[(CH₂)₂—O]ₙH.

It has been found that the gap in the protection of heat-treated wood can be overcome reliably by the method according to the invention. Owing to the combination of the heat treatment with the subsequent impregnation with dilute solutions of the above-described alkylamine derivatives, the essential advantage, viz. dispensing with a high degree of chemical timber preservation, is obtained. The alkylamine derivatives are to be regarded as markedly more advantageous from the toxicological and ecotoxicological aspect than conventional timber preservatives, most of which comprise heavy metals, such as, for example, “CCA salts” (copper/chromium/arsenic salts) or organocopper complexes. Also, studies have shown that the fumes developed during incineration (thermal exploitation or disposal) of timber comprising alkylamine derivatives do not differ from those of untreated timber, even at high feed rates, and that the composition of the ashes from timber treated thus also corresponds entirely to that of untreated timber.

The heat treatment can be effected in a manner known per se, preferably at a temperature of from 150 to 220° C. The treatment time depends on the dimensions of the components to be treated and on the treatment temperature; it is usually from 0.5 to 50 hours, preferably 5 to 20 hours.

Treatment of the timber with the amines or amine derivatives can be carried out by methods known per se, for example by applying differences in pressure, by diffusion impregnation or by surface treatment.

The treatment with amines and/or amine derivatives can be carried out after the thermal treatment or else before, with the proviso that the amines or amine derivatives in question have sufficient stability to high temperatures and not an unduly high volatility. Preference is given to carrying out the thermal treatment first.

The amine and/or amine derivative or the corresponding salt is preferably employed in the form of a 0.1 to 20% strength solution in water or an organic solvent. If appropriate, an inorganic or organic acid may be added to improve the solubility of amines which are sparingly soluble in water and/or for lowering the pH value of the solution.

Examples of organic solvents which are suitable are aliphatic or aromatic hydrocarbons such as various types of white spirit or liquid paraffin, toluene or xylenes, or fatty oils, in particular drying oils such as linseed oil.

The compositions for the treatment with amines and/or amine derivatives in the method according to the invention may, if appropriate, comprise additional active ingredients and/or adjuvants. These include, in particular:

Insecticides such as, for example, Imidacloprid for improving the resistance of the wood treated in accordance with the invention to insects, in particular termites

Colors, for example colorants and/or pigments for identifying, or imparting a decorative character to, the wood treated in accordance with the invention

Penetrants such as, for example, glycol derivatives for improving the depth of penetration and the distribution of the amines or amine derivatives in the wood treated in accordance with the invention

Water repellents such as, for example, wax dispersions, oils or silicone derivatives for improving the water-repellant properties of the wood treated in accordance with the invention

UV stabilizers such as, for example, micronized titanium oxides, zinc oxides or colloidal silica sols, or else organic UV stabilizers for improving the lightfastness and resistance to weathering of the wood treated in accordance with the invention

Binders such as, for example, plastics dispersions, drying oils, reactive resin solutions (for example melamine resin condensates) for improving the surface properties (hardness, smoothness etc.) of the wood treated in accordance with the invention

Supplementary biocides such as, for example, anti-mold fungicides, molluscicides or other biocides for improving the lifetime of the wood treated in accordance with the invention under specific stresses such as attack by Teredo navalis (“marine borer”) or Limnoria lignorum (aquatic sowbug) in seawater.

The examples which follow illustrate the implementation of the method according to the invention, but are not to be considered as limiting.

### EXAMPLES

Impregnation solutions were prepared in accordance with the following formulas:

Impregnation solution 1

| | |
|---|---|
| 0.5% | Cocodimethylamine |
| 0.5% | Lactic acid |
| 99.0% | Water |

Impregnation solution 2

| | |
|---|---|
| 1.0% | Benzalkonium chloride |
| 5.0% | Ethylene glycol |
| 94.0% | Water |

Impregnation solution 3

| | |
|---|---|
| 1.0% | Didecyldimethylammonium chloride |
| 10.0% | Butyldiglycol |
| 0.1% | Imidacloprid |
| 88.9% | Water |

Impregnation solution 4

| | |
|---|---|
| 1.00% | N,N-bis(3-aminopropyl)dodecylamine (Lonzabac ® 12) |
| 1.00% | Acetic acid |
| 0.01% | Fenoxycarb |
| 97.99% | Water |

Impregnation solution 5

| | |
|---|---|
| 0.2% | Dodecyldimethylamine oxide (Barlox ® 12) |
| 0.5% | Hexadecyldimethylamine oxide (Barlox ® 16) |
| 5.0% | Ethyl lactate |
| 0.5% | Acid dyestuff red |
| 93.8% | Water |

Impregnation solution 6

| | |
|---|---|
| 0.5% | Hexadecyldimethylamine oxide (Barlox ® 16) |
| 5.0% | Linseed fatty acid |
| 0.5% | Sodium hydroxide |
| 4.0% | Triethylene glycol |
| 90.0% | Water |

Impregnation solution 7 (anhydrous)

| | |
|---|---|
| 0.5% | Didecylmethylpoly(oxyethyl)ammonium propionate |
| | (Bardap ® 26) |
| 10.0% | Propylene glycol |
| 89.5% | White spirit K60 |

Impregnation solution 8

| | |
|---|---|
| 1.0% | Didecyldimethylammonium carbonate |
| 5.0% | Isopropyl alcohol |
| 1.0% | Dyestuff yellow |
| 10.0% | Paraffin wax dispersion 40% strength in water |
| 83.0% | Water |

Impregnation solution 9 (anhydrous)

| | |
|---|---|
| 2.0% | Didecylmethylpoly(oxyethyl)ammonium propionate |
| | (Bardap ® 26) |
| 70.0% | Linseed oil |
| 1.0% | Antioxidant (BHT) |
| 10.0% | Dipropylene glycol monomethyl ether |
| 17.0% | Liquid paraffin (low viscosity) |

Impregnation solution 10 (anhydrous)

| | |
|---|---|
| 1.0% | Cocoalkyldimethylbenzylammonium chloride |
| 5.0% | Fatty alcohol ethoxylate (HLB value 15) |
| 47.0% | Linseed oil |
| 47.0% | Liquid paraffin (low viscosity) |

Impregnation solution 11

| | |
|---|---|
| 5.0% | Dodecyldimethylamine oxide (Barlox ® 12) (30% strength) |
| 2.0% | Octadecyldimethylamine oxide (Barlox ® 18) (25% strength) |
| 10.0% | Soya fatty acid |
| 4.0% | Monoethanolamine |
| 79.0% | Water |

### Examples 1-11, Comparative Examples 1-2

Testing Procedure:

Whitewood samples were heated from 20° C. to 200° C. in a water vapor-saturated atmosphere in the course of 10 hours (with the temperature rising linearly over time) and held at 200° C. for a further 4 hours. After this heat treatment, the samples were made into test specimens (1.5×2.5×5.0 cm³) as specified in EN 113: 1996 and impregnated with impregnation solutions of examples 1 to 11. The comparative solutions also employed were pure water (“impregnation solution” 12, Comparative Example 1) and a mixture of equal parts linseed oil and paraffin oil (low viscosity) (impregnation solution 13, Comparative Example 2).

For the impregnation, the test specimens were exposed to a vacuum of approx. 1.3 mbar (approx. 1 Torr) for 2 hours as specified in EN 113, then immersed in the impregnation solution and, after the vacuum had been released, left submerged for a further 2 hours. The uptake of impregnation solution corresponded approximately to that of whitewood samples without heat treatment.

After the impregnation, the test specimens were conditioned (dried) for 4 weeks as specified in EN 113 and then tested with the following Basidiomycetes:

Gloeophyllum trabeum (Gt)

Poria placenta (Pp)

Coniophora puteana (Cp)

Antrodia vaillantii (Av)

A pass mark was given (+) when the weight loss of the test specimens amounted to less than 5% or a fail mark (−) when it amounted to 5% or more. The results are compiled in Table 1 which follows.

TABLE 1

| | | |
|---|---|---|
| Example | Impregnation | Fungal species |

| No. | Solution No. | Gt | Pp | Cp | Av |
|---|---|---|---|---|---|
| 1 | 1 | + | + | + | + |
| 2 | 2 | + | + | + | + |
| 3 | 3 | + | + | + | + |
| 4 | 4 | + | + | + | + |
| 5 | 5 | + | + | + | + |
| 6 | 6 | + | + | + | − |
| 7 | 7 | + | + | + | + |
| 8 | 8 | + | + | + | + |
| 9 | 9 | + | + | + | + |
| 10 | 10 | + | + | + | + |
| 11 | 11 | + | + | + | + |
| C1 | 12 | + | − | + | − |
| C2 | 13 | + | − | + | − |

What is claimed is:

1. A method for the protective treatment of wood, derived timber products and wood-like substrates by thermal treatment at 60-250° C., characterized in that the substrates to be protected are additionally treated with an amine and/or amine derivative of the formula 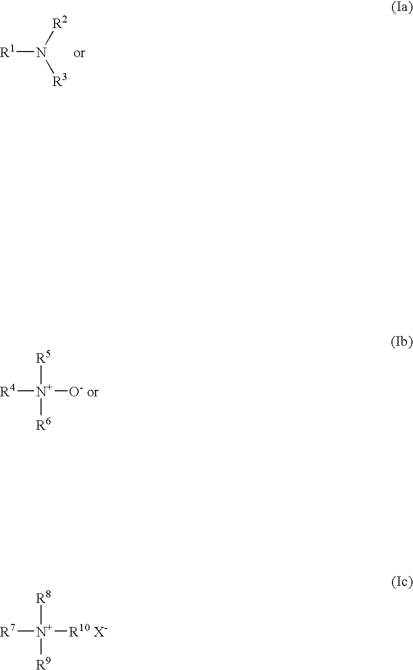
in which independently of one another
R¹ and R⁴ are C₆₋₂₄-alkyl,
R² and R³ are C₁₋₂₄-alkyl or CH₂)₃—NH₂,
R¹, R⁶, R⁸ and R⁹ are C₁₋₂₄-alkyl,
R⁷ is C₆₋₂₄-alkyl or benzyl,
R¹⁰ is C₁₋₂₄-alkyl or —[(CH₂)₂—O]ₙR¹ where n=1-20,
R¹¹ is hydrogen or optionally substituted phenyl
and X⁻ is a monovalent inorganic or organic anion or an equivalent of a polyvalent inorganic or organic anion
or with a corresponding salt.

2. The method as claimed in claim 1, characterized in that the treatment with the amine and/or amine derivative is carried out after the thermal treatment.

3. The method as claimed in claim 1 or 2, characterized in that the amine and/or amine derivative or the corresponding salt is employed in the form of a 0.1 to 20% strength solution in water or an organic solvent.

4. The method as claimed in claim 3, characterized in that the solution of the amine and/or amine derivative or of the corresponding salt additionally comprises at least one additive from the group consisting of insecticides, colors, penetrants, water repellants, UV stabilizers, binders, fungicides or molluscicides.

5. Timber, derived timber products and wood-like substrates, heat-treated and treated with an amine and/or amine derivative of the formula 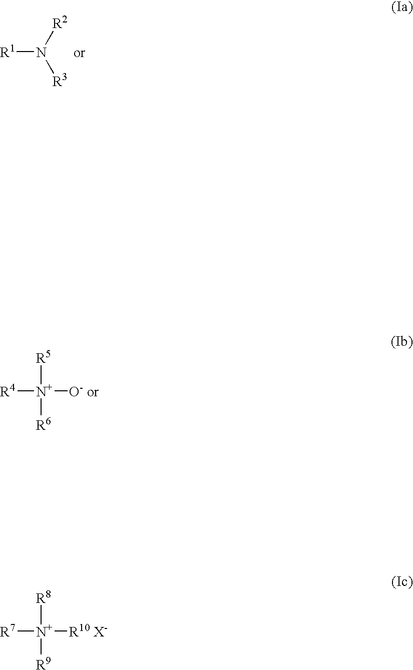
in which independently of one another
R¹ and R⁴ are C₆₋₂₄-alkyl,
R² and R are C₁₋₂₄-alkyl or —(CH₂)₃—NH₂,
R⁵, R⁶, R⁸ and R⁹ are C₁₋₂₄-alkyl,
R⁷ is C₆₋₂₄-alkyl or benzyl,
R¹⁰ is C₁₋₂₄-alkyl or —[(CH₂)₂—O]ₙR¹¹ where n=1-20,
R¹¹ is hydrogen or optionally substituted phenyl
and X⁻ is a monovalent inorganic or organic anion or an equivalent of a polyvalent inorganic or organic anion or with a corresponding salt.
